(19) United States
(12) Patent Application Publication
(10) Pub. No.: US 2025/0278112 A1
(43) Pub. Date: Sep. 4, 2025

(54) Processing System, Writing System For Real Time Clock Device, And Function Setting Method For Real Time Clock Device

(71) Applicant: SEIKO EPSON CORPORATION, Tokyo (JP)

(72) Inventor: Yasuhiro SUDO, Chino (JP)

(21) Appl. No.: 19/065,302

(22) Filed: Feb. 27, 2025

(30) Foreign Application Priority Data
Feb. 29, 2024 (JP) 2024-029444

(51) Int. Cl. G06F 1/14

(52) U.S. Cl. CPC G06F 1/14

(57) ABSTRACT

A processing system includes a reception unit configured to receive function selection information of a programmable real time clock device from a user terminal via a network, a processing unit configured to generate, based on the function selection information, information for writing for setting a function of the real time clock device, and a transmission unit configured to transmit the information for writing to the user terminal.

The present application is based on, and claims priority from JP Application Serial Number 2024-029444, filed Feb. 29, 2024, the disclosure of which is hereby incorporated by reference herein in its entirety.

### BACKGROUND

### 1. Technical Field

The present disclosure relates to a processing system, a writing system for a real time clock device, a function setting method for a real time clock device, and the like.

### 2. Related Art

A real time clock capable of performing selection operation on a user side is known. JP-A-2023-161717 discloses a real time clock with which a user is capable of setting, according to a type of an application, a type of an event to be stored together with a time stamp.

JP-A-2023-161717 is an example of the related art.

A real time clock device includes a plurality of functions. Items to set are subdivided for each of the functions. Lining up real time clock devices by the number of conceivable combinations of functions and setting items and a user selecting a real time clock device from the lined-up real time clock devices lacks convenience. For that reason, it is desired to construct a system and the like for enabling a user to select necessary functions and the like for one real time clock device.

### SUMMARY

An aspect of the present disclosure relates to a processing system including: a reception unit configured to receive function selection information of a programmable real time clock device from a user terminal via a network; a processing unit configured to generate, based on the function selection information, information for writing for setting a function of the real time clock device; and a transmission unit configured to transmit the information for writing to the user terminal.

Another aspect of the present disclosure relates to a writing system for a real time clock device, including: the processing system described above; the user terminal; and a writing device communicably connected to the user terminal and configured to write the information for writing to a nonvolatile memory of the real time clock device.

Another aspect of the present disclosure relates to a function setting method for a real time clock device, including: receiving function selection information of a programmable real time clock device from a user terminal via a network; generating, based on the function selection information, information for writing for setting a function of the real time clock device; and transmitting the information for writing to the user terminal.

### BRIEF DESCRIPTION OF THE DRAWINGS

FIG. 1 is a diagram illustrating a configuration example of a processing system.

FIG. 2 is a diagram illustrating a configuration example of a real time clock device.

FIG. 3 is a diagram illustrating a configuration example of a writing system for the real time clock device.

FIG. 4 is a diagram illustrating a display example of function selection of the real time clock device.

FIG. 5 is another diagram illustrating a display example of function selection of the real time clock device.

FIG. 6 is another diagram illustrating a display example of function selection of the real time clock device.

FIG. 7 is another diagram illustrating a display example of function selection of the real time clock device.

FIG. 8 is a diagram illustrating a display example of characteristic information.

### DESCRIPTION OF EMBODIMENTS

A preferred embodiment of the present disclosure is explained in detail below. The embodiment explained below does not unduly limit the content described in the claims. Not all of components explained in the embodiment are essential elements.

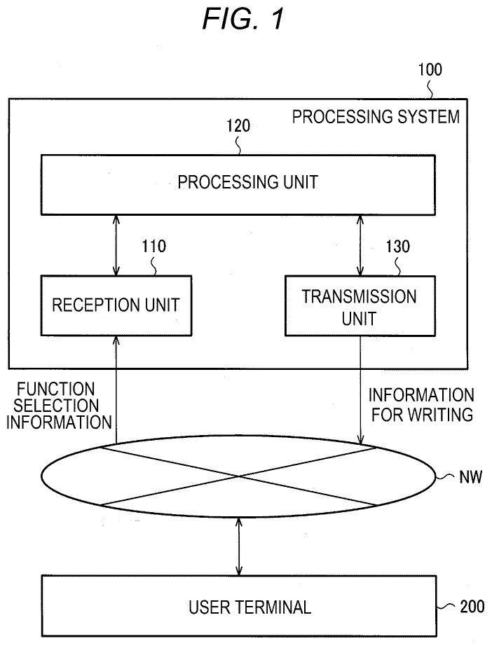

FIG. 1 is a diagram illustrating a configuration example of a processing system 100 in the present embodiment. In FIG. 1, the processing system 100 is connected to a user terminal 200 via a network NW. The network NW is specifically a public communication network such as the Internet but may partially include an intranet. The processing system 100 illustrated in FIG. 1 is illustrated as including one user terminal 200 but may include a plurality of user terminals 200.

As illustrated in FIG. 1, the processing system 100 includes a reception unit 110, a processing unit 120, and a transmission unit 130. The processing system 100 is a system managed by a manufacturer of a real time clock device 400 explained below and is implemented by a server or the like functioning as the reception unit 110, the processing unit 120, and the transmission unit 130. In the following explanation, the manufacturer of the real time clock device 400 is simply described as “manufacturer”. The server is a server used by the manufacturer and may be, for example, a physical server owned by the manufacturer or may be a cloud server present outside a base of the manufacturer. The cloud server may be a server managed by the manufacturer, a server contracted to be used by the manufacturer, or a server contracted to be managed by another person.

The reception unit 110 is a communication interface communicably connected to an external device via the network NW. The reception unit 110 can be implemented by an independent semiconductor device having a communication function conforming to a predetermined communication standard but may be implemented as a part of functions of a semiconductor device also having other functions. The predetermined communication standard is, for example, a wired communication standard such as Ethernet (registered trademark) or a wireless communication standard such as Wi-Fi (registered trademark) but may be another communication standard. In the following explanation, “communication connection conforming to a communication standard” is described as “communication connection” or simply described as “connection” as appropriate. The reception unit 110 in the present embodiment receives the function selection information of the real time clock device 400 from the user terminal 200. Details are explained below.

The processing unit 120 performs processing of the units of the processing system 100. The processing unit 120 is configured by the following hardware. The hardware includes a circuit for processing a digital signal but may further include a circuit for processing an analog signal. For example, the hardware can be configured by one or a plurality of circuit devices and one or a plurality of circuit elements implemented on a circuit board. The one or the plurality of circuit devices are, for example, integrated circuits (ICS) and field-programmable gate arrays (FPGAs). The one or the plurality of circuit elements are, for example, resistors and capacitors. The processing unit 120 is implemented by including at least one processor explained below. The processing unit 120 includes a memory that stores not-illustrated information and a processor that operates based on the information stored in the memory. The information is, for example, programs and various data. The processor includes hardware. Various processors such as a central processing unit (CPU), a graphics processing unit (GPU), and a digital signal processor (DSP) can be used as the processor. The memory may be a semiconductor memory such as a static random access memory (SRAM) or a dynamic random access memory (DRAM), may be a register, may be a magnetic storage device such as a hard disk drive (HDD), or may be an optical storage device such as an optical disk device. For example, the memory stores computer-readable instructions. The processor executes the instructions, whereby a part or all of the functions of the units of the processing system 100 are implemented as processing. The instructions may be instructions of an instruction set configuring a program or may be instructions for instructing a hardware circuit of the processor to perform operations.

The processing unit 120 in the present embodiment generates, based on the function selection information received by the reception unit 110, information for writing for setting a function of the real time clock device 400. Details are explained below.

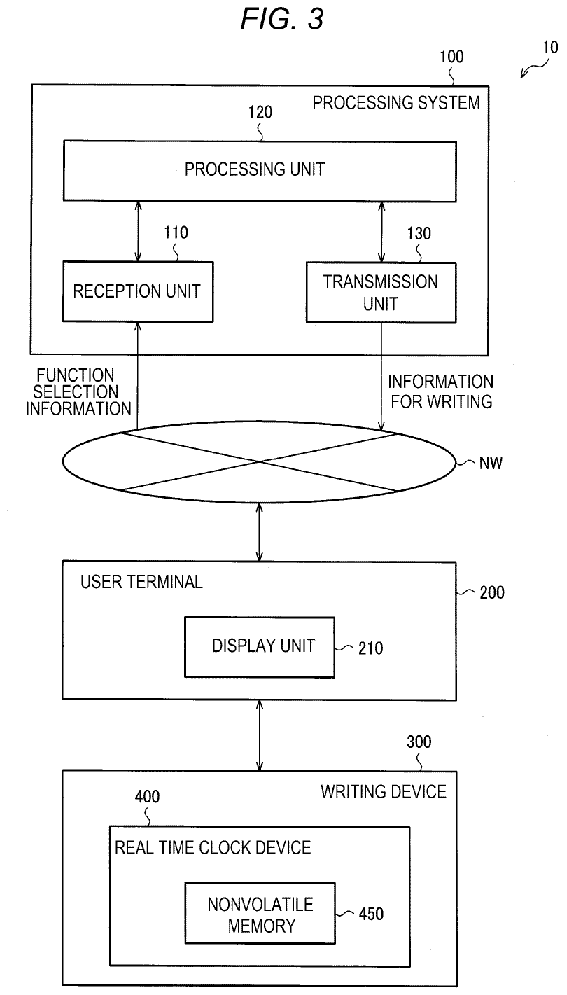

The transmission unit 130 is the same communication interface as the reception unit 110. That is, like the reception unit 110, the transmission unit 130 can be implemented by a semiconductor device having the communication function conforming to the predetermined communication standard. In FIG. 1, the reception unit 110 and the transmission unit 130 are illustrated as separate functional blocks. However, this does not prevent the reception unit 110 and the transmission unit 130 from being able to be configured by a single semiconductor device. The same applies to FIG. 3 referred to below. When the processing system 100 is a cloud system, one or a plurality of computers connected to the network NW may be provided in the processing system 100. In this case, each of the computers may include the reception unit 110, the processing unit 120, and the transmission unit 130. Alternatively, the reception unit 110 and the transmission unit 130 may be implemented by a communication device for connecting the entire cloud system to the network NW.

The user terminal 200 is a terminal used by a user. A personal computer is exemplified in the present embodiment. However, this does not prevent application to portable terminals such as a smartphone and a tablet terminal. Although not illustrated, the user terminal 200 includes a processor equivalent to the processing unit 120 explained above and has a function of a user terminal processing unit. Similarly, although not illustrated, the user terminal 200 includes a communication interface equivalent to the reception unit 110 explained above and has a function of a user terminal reception unit. Similarly, although not illustrated, the user terminal 200 includes a communication interface corresponding to the transmission unit 130 explained above and has a function of a user terminal transmission unit.

The user in the present embodiment is a person who uses the real time clock device 400 explained later and can also be considered a customer of the manufacturer. The customer refers to, for example, a person having a purchase record of the real time clock device 400 from the manufacturer or an organization to which the person belongs. However, the customer includes a so-called expected customer or an organization to which the expected customer belongs. Although the customer is assumed to be mainly a corporation, the customer may be an individual if the individual is likely to purchase a predetermined number of real time clock devices 400. The purchase record of the real time clock device 400 includes a record of receiving provision of a service relating to technical support for the real time clock device 400 besides a record of receiving provision of sales of the real time clock device 400. The expected customer refers to, for example, a person who is interested in the real time clock device 400 sold by the manufacturer and is likely to purchase the real time clock device 400 in the near future.

In the present embodiment, various external devices connected to the real time clock device 400 by the user, who is the customer, are collectively referred to as host device (not illustrated). The real time clock device 400 in the present embodiment can operate with a backup element (not illustrated) explained below even when a power supply voltage from a main power supply of a host device (not illustrated) is temporarily not supplied because the host device (not illustrated) falls into a sleep state or the like.

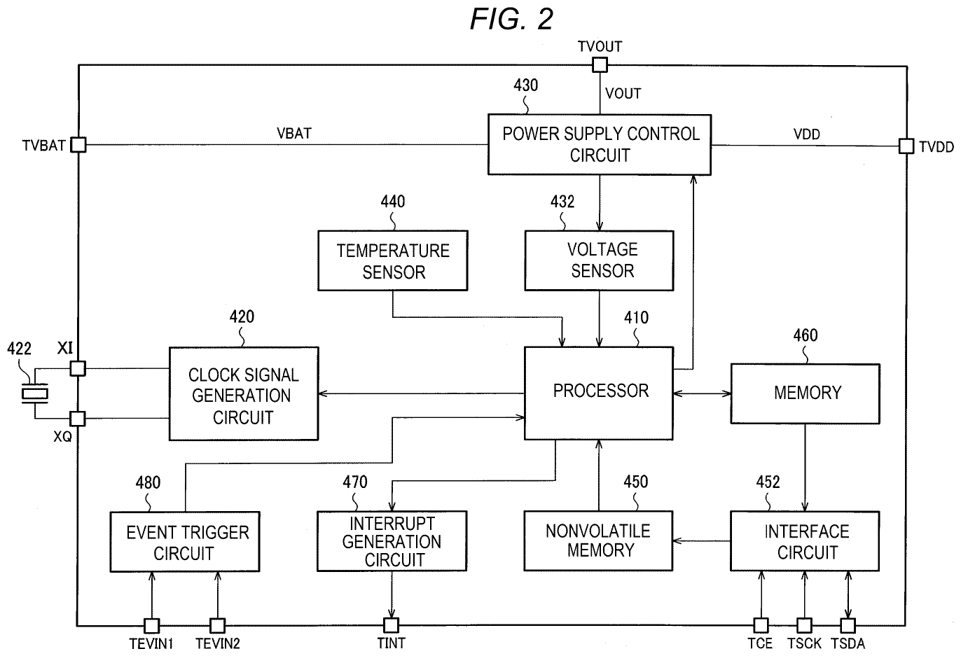

A main configuration of the real time clock device 400 relating to a method in the present embodiment is explained with reference to FIG. 2. FIG. 2 is a block diagram of a circuit device provided in the real time clock device 400. That is, the circuit device illustrated in FIG. 2 is implemented as, for example, an IC chip and is modularized as the real time clock device 400 by further including a predetermined package. That is, FIG. 2 can be considered as a diagram in which a portion relating to the package in the real time clock device 400 is omitted.

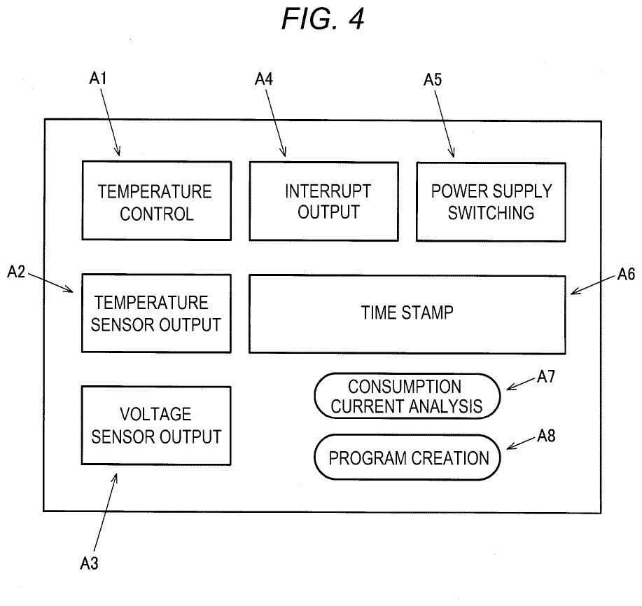

As explained below, the method in the present embodiment relates to the programmable real time clock device 400. However, not all of functions relating to the real time clock device 400 need be programmable and a part of the functions only has to be programmable. For example, a clocking function explained below can operate without requiring a program. On the other hand, functions illustrated in FIG. 4 and the like are programmable.

FIG. 2 is a diagram illustrating main components relating to the method in the present embodiment among the components provided in the real time clock device 400. The other components are omitted as appropriate. As an example, a temperature sensor 440 illustrated in FIG. 2 is representatively illustrated as a component provided in a temperature detection circuit (not illustrated). Illustration of components other than the temperature sensor 440 is omitted. For example, in FIG. 2, illustration of a power supply line for supplying electric power to various circuits and the like is omitted. In the following explanation, components not illustrated in FIG. 2 are explained while being supplemented according to necessity.

The circuit device illustrated in FIG. 2 includes a processor 410, a clock signal generation circuit 420, a power supply control circuit 430, a voltage sensor 432, a temperature sensor 440, a nonvolatile memory 450, an interface circuit 452, a memory 460, an interrupt generation circuit 470, and an event trigger circuit 480.

The circuit device illustrated in FIG. 2 includes terminals XI, XQ, TVDD, TVBAT, TVOUT, TEVIN1, TEVIN2, TINT, TCE, TSCK, and TSDA. Explanation of these terminals is included in explanation of the circuits described above. For example, a terminal such as the terminal TINT is more accurately coupled to an external terminal (not illustrated) of the package and the external terminal (not illustrated) is coupled to a terminal (not illustrated) on a host device side. For that reason, input and output of signals between these terminals and the host device (not illustrated) are performed via the external terminal (not illustrated) of the package. However, in the following explanation, in order to simplify the explanation, this is sometimes described as, for example, “input and output of signals are performed between these terminals and the host device (not illustrated)”.

The processor 410 performs various kinds of processing of the circuit device illustrated in FIG. 2. The processor 410 includes hardware. As the processor, various processors such as the CPU, the GPU, and the DSP explained above can be used. That is, the processor 410 in the present embodiment operates based on a program stored in the nonvolatile memory 450 explained below.

The clock signal generation circuit 420 causes a vibrator 422 to oscillate. For example, the clock signal generation circuit 420 is electrically coupled to the terminal XI and the terminal XQ and generates a clock signal by causing the vibrator 422 to oscillate. For example, the clock signal generation circuit 420 drives the vibrator 422 via a signal line coupled to the terminal XI and the terminal XQ to cause the vibrator 422 to oscillate. For example, the clock signal generation circuit 420 includes a drive circuit for oscillation (not illustrated) provided between the terminal XI and the terminal XQ. For example, the clock signal generation circuit 420 can be implemented by a transistor such as a bipolar transistor that realizes the drive circuit and an active element such as a capacitor or a resistor. As the clock signal generation circuit 420, for example, oscillation circuits of various types such as a Pierce type, a Colpitts type, an inverter type, and a Hartley type can be adopted. The clock signal generation circuit 420 can include a variable capacitance circuit (not illustrated) and can adjust an oscillation frequency by adjusting the capacitance of the variable capacitance circuit.

The vibrator 422 is an element that generates mechanical vibration with an electric signal. The vibrator 422 can be implemented by a vibrator element such as a quartz crystal vibrator element. For example, the vibrator 422 can be implemented by a thickness-shear vibrating quartz crystal vibrator element, a cut angle of which is an AT cut or an SC cut, a tuning fork type quartz crystal vibrator element, a double tuning fork type quartz crystal vibrator element, or the like. The vibrator 422 in the present embodiment can also be implemented by various vibrator elements such as a vibrator element other than the thickness-shear vibrating type, the tuning fork type and the double tuning fork type vibrator elements and a piezoelectric vibrator element made of a material other than quartz crystal. For example, a surface acoustic wave (SAW) resonator and a micro electro mechanical systems (MEMS) vibrator serving as a silicon vibrator formed using a silicon substrate can also be adopted as the vibrator 422.

By using a clock signal generated as explained above, a clock function and a calendar function of the real time clock device 400 are implemented. For example, the real time clock device 400 includes a clocking circuit (not illustrated) and performs clocking processing based on the clock signal to generate time information. For example, the clocking circuit (not illustrated) includes a frequency division circuit (not illustrated) that performs frequency division of the clock signal from the clock signal generation circuit to output a divided clock signal and a clocking counter (not illustrated) that performs clocking count processing based on the divided clock signal. Thus, the clocking circuit generates, for example, time information indicating the present time. The time information, which is clocking data, can include data indicating a second, a minute, an hour, a day, a month, a year, and the like but may also include data of a millisecond and a week. The millisecond may be 1/1024 second. For example, the clocking counter (not illustrated) includes counters for respectively counting a second, a minute, an hour, a day, a month, a year, and the like and generates time information through counting processing of these counters. The processor 410 may be configured to further function as a clocking circuit (not illustrated). As explained above, in the processing system 100 in the present embodiment, the real time clock device 400 includes the clock signal generation circuit 420 that generates a clock signal used for clocking.

The processor 410 may perform time stamp processing based on the generated time information. The time stamp processing refers to processing of causing, for example, according to occurrence of an event or the like, the memory 460 explained below to store, in correlation with each other, data for identifying the event or the like and time data of time when the event or the like occurred. Information in which the data for identifying the event or the like and the time data of the time when the event or the like occurred are correlated with each other is referred to as time stamp information. For example, the processor 410 may cause a host device (not illustrated) to output the time stamp information via the interface circuit 452 explained below. For example, when the host device (not illustrated) returns from the sleep state, the host device performs serial communication explained below with the real time clock device 400. Then, by receiving time stamp information generated in a period of the sleep state from the real time clock device 400, the host device (not illustrated) can grasp an event that occurred during the period of the sleep state.

The power supply control circuit 430 is a circuit that performs various kinds of power supply control such as switching control for the power supply voltage. The power supply control circuit 430 can also be called power supply switching control circuit or charging control circuit. The power supply control circuit 430 selects, with a method explained below, a main power supply voltage VDD or a backup power supply voltage VBAT. The selected power supply voltage is output from the terminal TVOUT as an internal power supply voltage VOUT. That is, although not illustrated, for example, the power supply control circuit 430 supplies, to the clock signal generation circuit 420, a predetermined operating voltage obtained by dividing the internal power supply voltage VOUT with a regulator (not illustrated) or the like. Similarly, the predetermined operating voltage is supplied from the power supply control circuit 430 to the voltage sensor 432, the temperature sensor 440, the nonvolatile memory 450, the interface circuit 452, the memory 460, the interrupt generation circuit 470, and the event trigger circuit 480.

The main power supply voltage VDD is supplied from a main power supply (not illustrated) coupled to the terminal TVDD. The main power supply (not illustrated) is, for example, an independent external power supply but may be, for example, a power supply provided in the host device (not illustrated). The backup power supply voltage VBAT is supplied from a backup element (not illustrated) coupled to the terminal TVBAT. For example, when the main power supply voltage VDD is supplied from a main power supply (not illustrated) to the real time clock device 400, the internal power supply voltage VOUT is the main power supply voltage VDD. For example, when the supply of the main power supply voltage VDD from the main power supply (not illustrated) to the real time clock device 400 is interrupted, the internal power supply voltage VOUT is immediately switched to the backup power supply voltage VBAT. Accordingly, for example, since the clock signal generation circuit 420, the clocking circuit (not illustrated), and the like explained above can continue the clocking operation because the power supply can be received even while the supply of the main power supply voltage VDD from the main power supply (not illustrated) is interrupted.

The backup element (not illustrated) is an element for retaining the backup power supply voltage VBAT and is, for example, a secondary battery or a super capacitor. Examples of the secondary battery include a lithium ion battery, a metal lithium battery, a nickel-cadmium battery, a sodium ion battery, a lead storage battery, and an all-solid-state battery or a semi-solid-state battery. The super capacitor is also called large capacity capacitor and examples of the super capacitor include an electric double layer capacitor, a pseudo capacitor, and a hybrid capacitor. When charging control explained below is not performed, a primary battery may be used as the backup element (not illustrated).

The voltage sensor 432 is provided in a voltage detection circuit (not illustrated) and outputs, with a method explained below, an analog backup power supply voltage VBAT, which is input via the power supply control circuit 430, as digital voltage data to the processor 410. The voltage detection circuit (not illustrated) may further include a comparison circuit (not illustrated). For example, the comparison circuit (not illustrated) includes a comparator and compares a voltage value of the main power supply voltage VDD and a threshold voltage value for detecting a voltage drop of the main power supply voltage VDD. When the voltage value of the main power supply voltage VDD is equal to or more than the threshold voltage value, the comparison circuit (not illustrated) outputs a high level comparison result signal to the processor 410. When the voltage value of the main power supply voltage VDD is less than the threshold voltage value, the comparison circuit outputs a low level comparison result signal to the processor 410. The processor 410 transmits, based on, for example, the input low level comparison result signal, an instruction signal for switching the internal power supply voltage VOUT from the main power supply voltage VDD to the backup power supply voltage VBAT to the power supply control circuit 430. The power supply control circuit 430 controls a switch (not illustrated) or the like based on the instruction signal received from the processor 410 and switches the internal power supply voltage VOUT from the main power supply voltage VDD to the backup power supply voltage VBAT.

The voltage sensor 432 includes, for example, a current supply circuit (not illustrated), an oscillation circuit (not illustrated), a counter circuit (not illustrated), and an arithmetic circuit (not illustrated). The current supply circuit (not illustrated) supplies a supply current having a current value corresponding to a voltage value of the input analog backup power supply voltage VBAT to the oscillation circuit (not illustrated). The oscillation circuit (not illustrated) outputs a clock signal having an oscillation frequency corresponding to a current value of the supplied current to the counter circuit (not illustrated). The counter circuit (not illustrated) performs count processing of counting, in a given period, a clock signal input from the oscillation circuit (not illustrated) and outputs data of a count value based on the count processing to the arithmetic circuit (not illustrated). The arithmetic circuit (not illustrated) calculates, based on the received count value, digital voltage data corresponding to the voltage value of the analog backup power supply voltage VBAT.

The processor 410 receives the digital voltage data corresponding to the backup power supply voltage VBAT. The processor 410 compares each threshold voltage data stored in the nonvolatile memory 450 and the received voltage data and performs control based on a comparison result. The threshold voltage data is voltage data used to determine a state of the backup element (not illustrated). For example, voltage data relating to a threshold for determining whether the backup element (not illustrated) is in a fully charged state is referred to as full charge threshold voltage data. Similarly, voltage data relating to a threshold for determining whether the backup element (not illustrated) requires recharging is referred to as recharging threshold voltage data. Similarly, voltage data relating to a threshold for determining whether the backup element (not illustrated) is in an over-discharged state is referred to as over-discharge threshold voltage data. For example, the processor 410 compares the received voltage data and the recharging threshold voltage data. When determining that the received voltage data is lower than the recharging threshold voltage data, the processor 410 outputs, to the power supply control circuit 430, an instruction signal for controlling the switch (not illustrated) or the like to couple the main power supply (not illustrated) and the backup element (not illustrated). As explained above, in the processing system 100 in the present embodiment, the power supply control circuit 430 performs charging control based on the comparison of the backup power supply voltage VBAT from the backup element and the threshold voltage.

For example, the processor 410 compares the received voltage data and the full charge threshold voltage data. When determining that the received voltage data is higher than the full charge threshold voltage data, the processor 410 outputs, to the power supply control circuit 430, an instruction signal for controlling the switch (not illustrated) or the like to stop charging the backup element (not illustrated) from the main power supply (not illustrated). There may be plurality of the recharging threshold voltage data, the full charge threshold voltage data, and the like explained above according to types of the backup element (not illustrated). The user can select the data as appropriate with a method explained below. As explained above, in the processing system 100 in the present embodiment, the real time clock device 400 includes a power supply control circuit that performs charging control of the backup element by the main power supply voltage.

Although an example in which the voltage sensor 432 outputs the digital voltage data based on the backup power supply voltage VBAT is explained above, the digital voltage data that can be output by the voltage sensor 432 is not limited to this. For example, although not illustrated, the circuit device may be configured such that, for the main power supply voltage VDD and the internal power supply voltage VOUT, the digital voltage data can be output from the voltage sensor 432 by the same method as in the case of the backup power supply voltage VBAT explained above.

The temperature sensor 440 outputs temperature detection data to the processor 410. More specifically, the temperature sensor 440 is provided in the temperature detection circuit (not illustrated). For example, the temperature sensor 440 generates a temperature-dependent voltage using a circuit element having temperature dependency and outputs an analog temperature detection voltage based on a temperature independent voltage. An A/D conversion circuit (not illustrated) provided in the temperature detection circuit outputs, to the processor, digital temperature detection data obtained by A/D converting the temperature detection voltage.

The processor 410 functions as a temperature compensation circuit and outputs, based on the received temperature detection data, to the clock signal generation circuit 420, temperature compensation data for making the frequency of the clock signal generation circuit 420 constant regardless of temperature. For example, the processor 410 outputs the temperature compensation data to the clock signal generation circuit 420 by extracting the temperature compensation data corresponding to the received temperature detection data from a look-up table in which temperature characteristics of the oscillation frequency are tabled. In this case, the processor 410 may cause, for example, the nonvolatile memory 450 to store the look-up table. Alternatively, the processor 410 may output the temperature compensation data by substituting the temperature detection data in a polynomial function that approximates the temperature characteristics of the oscillation frequency. This makes it possible to reduce variations in the oscillation frequency of the clock signal generation circuit 420. When an output frequency of such temperature compensation data is increased, the accuracy of the oscillation frequency of the clock signal generation circuit 420 can be further improved. However, power consumption of the real time clock device 400 increases.

The nonvolatile memory 450 is, for example, a flash memory including a MONOS (Metal Oxide Nitride Oxide Silicon) memory cell but may be an EEPROM (Electrical Erasable Programmable Read Only Memory) including a floating gate memory cell. The nonvolatile memory 450 includes data such as an instruction set for causing the real time clock device 400 to operate but may further include the various threshold voltage data explained above, data relating to temperature compensation, and the like.

The interface circuit 452 performs communication based on a given communication standard with an external processing device. For example, the interface circuit 452 performs serial communication by an I2C (Inter-Integrated Circuit), an SPI (Serial Peripheral Interface), or the like. When the serial communication by the SPI is performed, a relation is that the host device (not illustrated) is a main and the real time clock device 400 is a replica. For example, the interface circuit 452 performs serial communication based on data transferred via the terminal TSDA and a clock signal input via the terminal TSCK. When serial communication by a three-wire SPI is performed, the terminal TSDA serves as a data input/output terminal and the terminal TCE serves as a chip select terminal. The interface circuit 452 also functions as an interface with a writing device 300 explained below when information for writing explained below is written in the nonvolatile memory 450.

The memory 460 functions as a working memory of the processor 410. The memory 460 may store the digital voltage data corresponding to the backup power supply voltage VBAT explained above and data of a time stamp explained below. The memory 460 is specifically a volatile memory and is, for example, a static random access memory (SRAM). However, various volatile memories such as a dynamic random access memory (DRAM) can be adopted.

The interrupt generation circuit 470 outputs an interrupt signal via the terminal TINT based on a command output from the processor 410. Accordingly, for example, the output interrupt signal can be output to the host device (not illustrated). Accordingly, the host device (not illustrated) can perform predetermined interrupt processing. As an example, the processor 410 compares a value of the digital voltage data corresponding to the backup power supply voltage VBAT and a value of the over-discharge voltage data stored in the nonvolatile memory 450. When determining that the value of the voltage data is lower than the value of the over-discharge voltage data, the processor 410 controls the interrupt generation circuit 470 such that the interrupt signal is output from the interrupt generation circuit 470. Therefore, the host device (not illustrated) having received the interrupt signal can detect that the backup voltage by the backup element (not illustrated) has decreased.

The event trigger circuit 480 outputs an event trigger signal to the processor 410. In response to the event trigger signal, the processor 410 selects at least one of a plurality of kinds of event data as target event data, which is a storage target, and selects time data generated by the clocking circuit (not illustrated) as target time data, which is a storage target. Then, the processor 410 performs time stamp processing for causing the memory 460 to store the target time data and the target event data in association with each other.

For example, the event trigger circuit 480 outputs an event trigger signal corresponding to an input signal input from the host device (not illustrated). As an example, when detecting a rising edge satisfying a predetermined condition for an input signal input to the terminal TEVIN1, the event trigger circuit 480 outputs an event trigger signal corresponding to the input signal. Kinds of events are classified according to states or the like of the terminals TEVIN1 and TEVIN2 coupled to the event trigger circuit 480. The event trigger circuit 480 may output the event trigger signal when there is access to the interface circuit 452 from the host device (not illustrated). The event trigger circuit 480 may output the event trigger signal when a predetermined condition concerning an internal state of the real time clock device 400 is satisfied. The predetermined condition is, for example, that temperature detected by the temperature sensor 440 deviates from a predetermined temperature range, that a voltage detected by the voltage sensor 432 deviates from a predetermined voltage range, or the like.

As explained above, a function of the real time clock device 400 explained above can be selected by the user. That is, since the specifications of the real time clock device 400 are finally decided by the determination of the user, a selling source sells the real time clock device 400 that is in a state in which the user can select a function.

Thus, for example, the manufacturer may distribute predetermined software to the user in order to examine the specifications of the real time clock device 400 for the user. The predetermined software only has to be able to download a program for installing the predetermined software in the user terminal 200 from, for example, a Web page designated by the manufacturer. Alternatively, the predetermined software may function as a part of a writing program explained below.

For example, although not illustrated in FIG. 1, when the user starts the predetermined software, a dedicated setting screen is displayed on the display unit 210 of the user terminal 200. The predetermined software is based on the premise that the predetermined software operates when the user terminal 200 is connected to the processing system 100 via the network NW. For that reason, it is assumed that, in using the predetermined software, the user has agreed with the manufacturer that function selection information is transmitted from the user terminal 200 to the processing system 100 and that information for writing is transmitted from the processing system 100 to the user terminal 200. For example, the user may promise, according to necessity, with the manufacture that the function selection information is managed as confidential information. As explained below with reference to FIG. 3, the same applies when the function selection information is generated further using the writing device 300.

Then, the user selects selectable items for various functions of the real time clock device 400 on the dedicated setting screen. Accordingly, the function selection information is generated.

Then, the user transmits the function selection information from the user terminal 200 to the processing system 100 with a method explained below or the like. The transmitted function selection information is received via the reception unit 110. The processing unit 120 generates information for writing based on the received function selection information. For example, the processing unit 120 performs, for example, processing of generating a source code based on the function selection information, processing of converting the source code into binary data that can be understood by the processor 410, processing of adding address information of the nonvolatile memory 450, which is a writing target, to the binary data. Accordingly, the information for writing is generated. Then, the processing unit 120 transmits the generated information for writing to the user terminal 200 via the transmission unit 130. Accordingly, the user can acquire the information for writing. Accordingly, the user can write the acquired information for writing in the nonvolatile memory 450 at any timing.

As explained above, the processing system 100 in the present embodiment includes the reception unit 110 that receives the function selection information of the programmable real time clock device 400 from the user terminal 200 via the network NW, the processing unit 120 that generates, based on the function selection information, the information for writing for setting the function of the real time clock device 400, and the transmission unit 130 that transmits the information for writing to the user terminal 200.

As explained above, since the processing system 100 in the present embodiment includes the reception unit 110 and the transmission unit 130 explained above, the processing system 100 can transmit and receive data to and from the user terminal 200 via the network NW. Since the processing system 100 in the present embodiment includes the processing unit 120 explained above, the processing system 100 can generate the information for writing based on the function selection information of the programmable real time clock device 400. Accordingly, by transmitting the function selection information from the user terminal 200, the user terminal 200 can construct a mechanism that can automatically receive the information for writing. Accordingly, it is possible to improve the convenience of the programmable real time clock device 400.

The real time clock device 400 includes the plurality of functions. However, details about which function is used by the user or details about setting items of the function used by the user are different depending on the user. For that reason, conceivable combinations are enormous and impose a large burden on the manufacturer. It is inconvenient for the user to place an order for the customized real time clock device 400 after considering the details of the specification of the real time clock device 400. This lacks convenience of the real time clock device 400. In this regard, by applying the method in the present embodiment, the user can automatically acquire, by determining function selection information of the programmable real time clock device 400, the information for writing based on the determined function selection information. Accordingly, the user can easily set functions of the programmable real time clock device 400. Accordingly, it is possible to improve the convenience of the real time clock device 400.

The method in the present embodiment may be implemented as a function setting method for the real time clock device 400. That is, the present embodiment relates to a function setting method for the real time clock device 400 that receives function selection information of the programmable real time clock device 400 from the user terminal 200 via the network NW, generates, based on the function selection information, information for writing for setting a function of the real time clock device 400, and transmits the information for writing to the user terminal 200. Therefore, the same effects as the effects explained above can be obtained.

In the processing system 100 in the present embodiment, the information for writing may be information written in the nonvolatile memory 450 of the real time clock device 400. Therefore, even if the power supply to the real time clock device 400 is stopped, evaluation of the real time clock device 400 can be continued when the power supply is performed again.

The method in the present embodiment is not limited to the above. Various modified implementations such as addition of components are possible. For example, the processing system 100 in the present embodiment may be configured to be provided in the writing system 10 of the real time clock device 400 illustrated in FIG. 3 in order to write the generated information for writing in the real time clock device 400.

In FIG. 3, the user terminal 200 includes the display unit 210 and is further connected to the writing device 300. For example, when the user terminal 200 is a personal computer, the display unit 210 is a liquid crystal display or the like. The writing device 300 is a device that writes information for writing in the real time clock device 400. For example, the writing device 300 includes, on a circuit board, an interface for connection to the user terminal 200 and a socket in which a package of the real time clock device 400 fits. That is, the writing device 300 includes the same interface circuit as the interface circuit 452 explained above.

For example, when considering evaluation of the programmable real time clock device 400, the user asks the manufacturer and receives a sample for evaluation and the writing device 300 from the manufacturer. Then, for example, the user starts software for writing in the user terminal 200 and writes the information for writing in the sample for evaluation using the software for writing. The user only has to install the software for writing in the user terminal 200 using, for example, a CD-ROM attached to the writing device 300. Alternatively, the user may download an installation program for the software for writing from a Web page designated by the manufacturer. Alternatively, when the user terminal 200 and the writing device 300 are connected via a USB cable or the like attached to the writing device 300, the software for writing may be automatically installed in the user terminal 200.

The software for writing may have the same function as the function of the predetermined software explained above. For example, when the user starts the software for writing, a screen relating to the software for writing is displayed on the display unit 210. Then, the user performs operation of selecting a function of the real time clock device 400 on the displayed screen. Accordingly, as explained above, the function selection information is transmitted from the user terminal 200 to the processing system 100 and the information for writing corresponding to the function selection information is transmitted from the processing system 100 to the user terminal 200. Then, the user operates the user terminal 200 and writes the received information for writing in the nonvolatile memory 450 using the writing device 300 connected to the user terminal 200.

As described above, the writing system 10 of the real time clock device 400 in the present embodiment includes the processing system 100, the user terminal 200, and the writing device 300 that is communicably connected to the user terminal 200 and writes the information for writing to the nonvolatile memory 450 of the real time clock device 400. Therefore, by selecting a function of the real time clock device 400, the user can construct a mechanism for immediately writing the information for writing based on the selected function in the nonvolatile memory 450 of the real time clock device 400. Accordingly, it is possible to improve the convenience of the real time clock device 400.

When receiving the information for writing corresponding to the function selection information, the user terminal processing unit may automatically perform processing for writing the received information for writing in the nonvolatile memory 450. As explained above, in the function setting method for the real time clock device 400 in the present embodiment, the user terminal 200 receives the information for writing and writes the received information for writing in the nonvolatile memory 450 of the real time clock device 400 via the writing device 300. Therefore, by selecting a function of the real time clock device 400, the user can construct a mechanism for automatically writing the information for writing based on the selected function in the nonvolatile memory 450 of the real time clock device 400.

The screen related to the predetermined software explained above may be like, for example, a screen example illustrated in FIG. 4. The screen example illustrated in FIG. 4 includes images concerning a plurality of setting items. The plurality of setting items include, for example, a setting item related to temperature control indicated by A1, a setting item related to temperature sensor output indicated by A2, a setting item related to voltage sensor output indicated by A3, a setting item related to interrupt output indicated by A4, a setting item related to power supply switching indicated by A5, and a setting item related to a time stamp indicated by A6.

The “temperature adjustment” in the present embodiment refers to adjusting the clock frequency output from the clock signal generation circuit 420 in response to the temperature variation around the real time clock device 400. Specifically, for example, as explained above, the processor 410 transmits temperature compensation data to the clock signal generation circuit 420 and the variable capacitance of the variable capacitance circuit (not illustrated) provided in the clock signal generation circuit 420 is adjusted. Accordingly, the frequency of a clock signal output from the clock signal generation circuit 420 is maintained within a fixed range. Accordingly, the accuracy of the clock function and the like explained above can be improved.

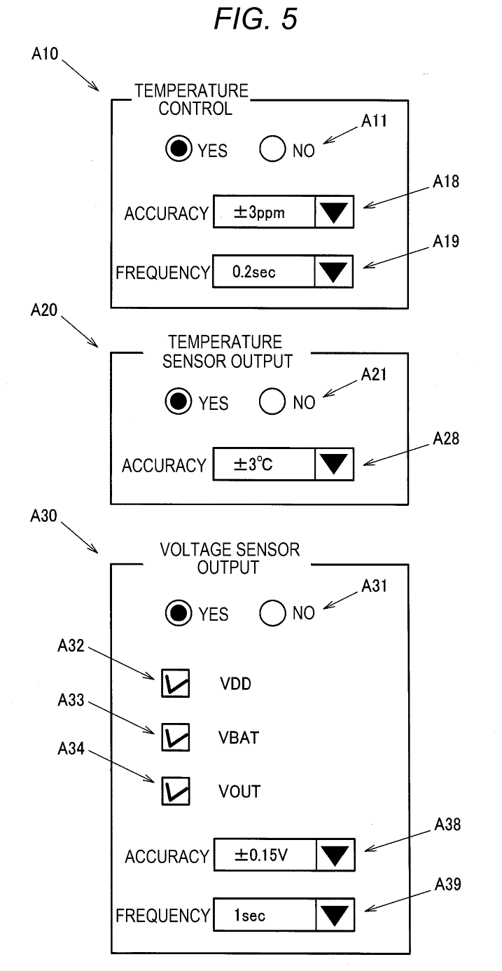

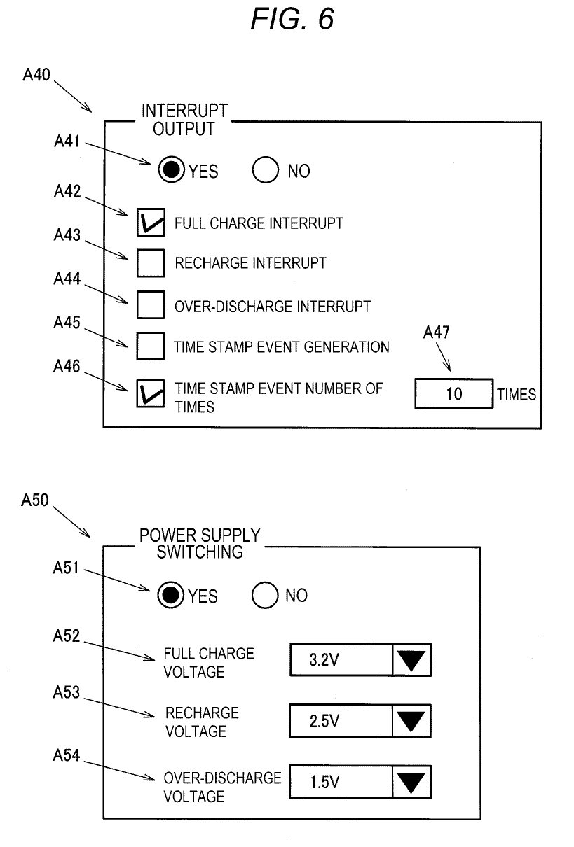

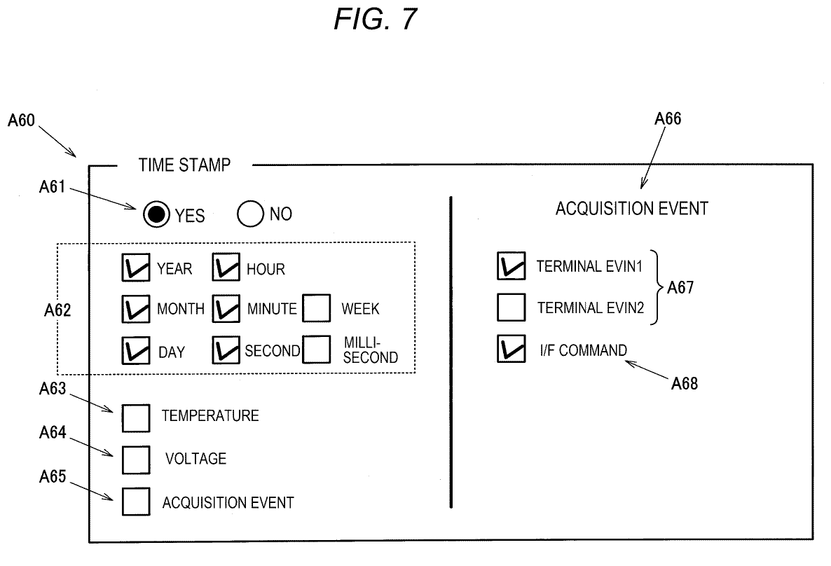

Setting items illustrated in A1 to A6 in FIG. 4 are more specifically explained with reference to FIGS. 5, 6, and 7. A setting item of A10 in FIG. 5 illustrates the setting item of A1 in FIG. 4 more in detail, a setting item of A20 in FIG. 5 illustrates the setting item of A2 in FIG. 4 more in detail, and a setting item of A30 in FIG. 5 illustrates the setting item of A3 in FIG. 4 more in detail. Similarly, a setting item of A40 in FIG. 6 illustrates the setting item of A4 in FIG. 4 more in detail and a setting item of A50 in FIG. 6 illustrates the setting item of A5 in FIG. 4 more in detail. Similarly, a setting item of A60 in FIG. 7 illustrates the setting item of A6 in FIG. 4 more in detail.

More specifically, an image illustrated in A10 in FIG. 5 includes a radio button image concerning setting of presence or absence of temperature control illustrated in A11, a drop-down image concerning selection of accuracy illustrated in A18, and a drop-down image concerning selection of a frequency illustrated in A19. For example, when the user selects a radio button image of “Yes”, the real time clock device 400 performs temperature control. In setting illustrated in FIG. 5, the processor 410 outputs temperature compensation data at every 0.2 second such that the frequency of a clock signal output from the clock signal generation circuit 420 does not deviate from a range of +3 ppm with respect to a set frequency. As explained above, in the processing system 100 in the present embodiment, the function selection information is information for selecting the frequency accuracy of the clock signal. Therefore, it is possible to set the frequency accuracy of the clock signal of the real time clock device 400 considering a situation of the user.

More specifically, an image illustrated in A20 in FIG. 5 includes a radio button image concerning setting of presence or absence of a temperature sensor output illustrated in A21 and a drop-down image concerning selection of accuracy illustrated in A28. The accuracy illustrated in A28 is the accuracy of a value of temperature digitally output from the temperature sensor 440. When the user selects “Yes” in the radio button image relating to A11, the user may also set the radio button image relating to A21 such that “Yes” is selected.

More specifically, an image illustrated in A30 in FIG. 5 includes a radio button image concerning setting of presence or absence of a voltage sensor output illustrated in A31, a drop-down image concerning selection of accuracy illustrated in A38, and a drop-down image concerning selection of a frequency illustrated in A39. Further, the image illustrated in A30 includes check box images relating to target voltages detected by the voltage sensor 432 as illustrated in A32, A33, and A34. The target voltages detected by the voltage sensor 432 are, for example, the main power supply voltage VDD, the backup power supply voltage VBAT, and the internal power supply voltage VOUT. In the setting illustrated in FIG. 5, the processor 410 controls the voltage sensor 432 to output digital data of the main power supply voltage VDD, the backup power supply voltage VBAT, and the internal power supply voltage VOUT at accuracy of ±0.15 V at every second.

An image illustrated in A40 in FIG. 6 includes, for example, a radio button image concerning setting of presence or absence of an interrupt output illustrated in A41, a check box image illustrated in A42, a check box image illustrated in A43, a check box image illustrated in A44, a check box image illustrated in A45, a check box image illustrated in A46, and a text field image illustrated in A47. For example, when the user checks the check box illustrated in A42, a program is created such that an event in which charging of a backup element has been completed occurs as an interrupt event. That is, when the charging of the backup element is completed, the processor 410 controls the interrupt generation circuit 470 to output an interrupt signal from the terminal TINT. Similarly, when the check box illustrated in A43 is checked, the processor 410 controls the interrupt generation circuit 470 to output the interrupt signal from the terminal TINT when determining that the backup element (not illustrated) needs to be charged again. Similarly, when the check box illustrated in A44 is checked, the processor 410 controls the interrupt generation circuit 470 to output the interrupt signal from the terminal TINT when determining that over-discharge of the backup element (not illustrated) has occurred.

When the check box illustrated in A45 is checked, the processor 410 controls the interrupt generation circuit 470 to output the interrupt signal from the terminal TINT when the time stamp processing is performed. When the check box illustrated in A46 is checked, the processor 410 controls the interrupt generation circuit 470 to output the interrupt signal from the terminal TINT when the number of times the time stamp processing is performed coincides with the number of times of input to the text field in A47.

An image illustrated in A50 in FIG. 6 includes, for example, a radio button image concerning setting of presence or absence of power switching illustrated in A51. That is, in the processing system 100 in the present embodiment, the function selection information is operation setting information of the power supply control circuit 430. Therefore, the user can perform operation setting for the power supply control circuit 430 considering a situation of the user.

The image illustrated in A50 in FIG. 6 includes a pull-down menu image for selecting a voltage value relating to full charge threshold voltage data illustrated in A52, a pull-down menu image for selecting a voltage value relating to recharging threshold voltage data illustrated in A53, and a pull-down menu image for selecting a voltage value relating to over-discharge voltage data illustrated in A54. As explained above, in the processing system 100 in the present embodiment, the operation setting information is setting information of a threshold voltage. Therefore, an appropriate threshold voltage can be set according to the backup element (not illustrated) provided in the real time clock device 400.

An image illustrated in A60 in FIG. 7 includes, for example, a radio button image concerning setting of presence or absence of a time stamp illustrated in A61, a group of check box images illustrated in A62, a check box image illustrated in A63, a check box image illustrated in A64, and a check box image illustrated in A65. The group of check boxes illustrated in A62 includes check boxes relating to setting of time data relating to a time stamp. For example, when the check box illustrated in A63 is checked, the processor 410 performs the time stamp processing, for example, when temperature detected by the temperature sensor 440 is outside a predetermined range. For example, when the check box illustrated in A64 is checked, the processor 410 performs the time stamp processing, for example, when voltage data concerning the backup power supply voltage VBAT detected by the voltage sensor 432 falls below a predetermined value. For example, when the check box illustrated in A65 is checked, the processor 410 performs the time stamp processing on, for example, all the acquired events. As illustrated in A66, the image illustrated in A60 includes an image concerning a detailed setting item of an acquisition event. An image in A66 includes, for example, a check box image for selecting an input terminal coupled to the event trigger circuit 480 as illustrated in A67 and a check box image for selecting an input terminal (for example, the terminal TSDA) input to the interface circuit 452 as illustrated in A68. For example, in the case of setting illustrated in FIG. 7, even if the event trigger circuit 480 receives a signal input via the terminal EVIN2, the processor 410 does not perform the time stamp processing.

The user operates, for example, a non-illustrated keyboard of the user terminal 200 to set the setting items in FIGS. 5 to 7 and select the button image in A7 in FIG. 4. Accordingly, the user terminal processing unit (not illustrated) generates a characteristic information generation instruction and transmits the generated characteristic information generation instruction to the reception unit 110 via the user terminal transmission unit (not illustrated). The characteristic information generation instruction includes function selection information. More specifically, for example, a packet of communication data transmitted from the user terminal transmission unit (not illustrated) to the reception unit 110 includes data concerning items set by the user about the setting items in FIGS. 5 to 7 besides data for the processing unit 120 to start generation of characteristic information. That is, the function selection information is information selected by the user for the setting items in FIGS. 5 to 7.

Then, the processing unit 120 generates characteristic information based on the function selection information at the time when the characteristic information generation instruction is performed. In other words, in the processing system 100 in the present embodiment, when the reception unit 110 receives the characteristic information generation instruction from the user terminal 200 via the network NW, the processing unit 120 generates characteristic information based on the function selection information at the time when the characteristic information generation instruction is performed.

The processing unit 120 analyzes the packet of the communication data received by the reception unit 110 and acquires data concerning the setting items set in the user terminal 200 by the user. The processing unit 120 generates characteristic information of the real time clock device 400 based on the acquired data concerning the setting item. In other words, in the processing system 100 in the present embodiment, the processing unit 120 generates, based on the function selection information, characteristic information of the real time clock device 400 at the time when the function selected by the user is set in the real time clock device 400. Therefore, a mechanism for generating characteristic information of the real time clock device 400 corresponding to the function selected by the user can be constructed.

Then, the processing unit 120 transmits the characteristic information of the real time clock device 400 to the user terminal 200 via the transmission unit 130. More specifically, for example, the processing unit 120 performs processing of creating Web page data concerning the characteristic information and processing of transmitting the created Web page data to the user terminal 200 via the transmission unit 130.

A communication packet relating to the transmitted web page data may further include command data for causing the user terminal processing unit (not illustrated) to start a Web browser and display a Web page. Accordingly, the user terminal processing unit (not illustrated) receives the Web page data via the user terminal reception unit (not illustrated), starts the Web browser, and displays the Web page relating to the received characteristic information. The characteristic information may not be Web page data if the characteristic information is data that can be displayed on the screen on the writing program. Various modified implementations are possible. As explained above, in the processing system 100 in the present embodiment, the processing unit 120 performs processing of displaying the characteristic information on the display unit 210 of the user terminal 200. Therefore, the user can view the characteristic information based on the function selection information through the display unit 210.

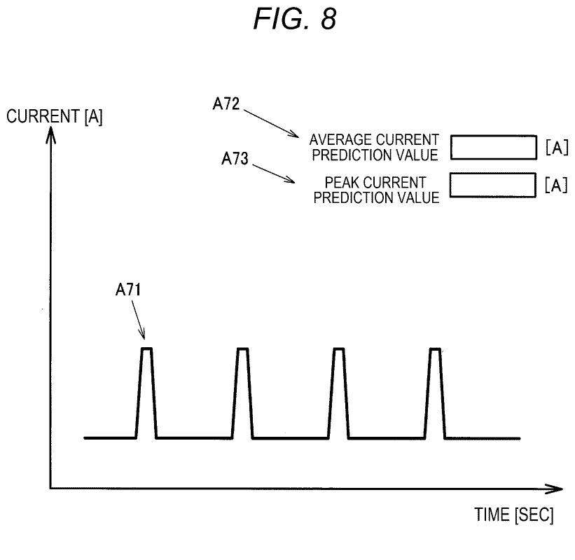

FIG. 8 is a screen example relating to characteristic information displayed on the display unit 210. FIG. 8 illustrates time series data of a consumption current value estimated by a simulation. In the time series data, for example, a peak occurs in a waveform based on the time series data as illustrated in A71 according to operation of various modules relating to the temperature control or the like explained above. For example, when the user selects a frequency illustrated in A19 in FIG. 5 to be high, time series data in which an interval between peaks relating to A71 in FIG. 8 is narrower is illustrated. An average current prediction value illustrated in A72 and a peak current prediction value illustrated in A73 are illustrated. As explained above, in the processing system 100 in the present embodiment, the characteristic information is power consumption information. Therefore, the user can grasp power consumption information of the real time clock device 400 corresponding to a set function. The average current prediction value is also referred to as Typ value (typical value) and the peak current prediction value is also referred to as Max value (maximum value). The characteristic information is the power consumption information in the present embodiment but is not limited to this. For example, the characteristic information may be start time information representing a start time from when the real time clock device 400 is turned on until the real time clock device 400 can output time information.

By viewing the characteristic information illustrated in FIG. 8, the user can determine optimum specifications of the real time clock device 400 considering a balance among a selected function, assumed power consumption, a backup element to be used, and the like. When determining that characteristic information acquired by finally pressing the button image in A7 in FIG. 4 is equivalent to characteristic information desired by the user, the user presses the button image illustrated in A8 in FIG. 4. Accordingly, the user terminal processing unit transmits an information for writing generation instruction to the processing system 100. A packet of transmission data relating to the information for writing generation instruction includes data relating to the function selection information.

When receiving the information for writing generation instruction via the reception unit 110, the processing unit 120 generates information for writing based on the function selection information included in the information for writing generation instruction. As explained above, in the processing system 100 in the present embodiment, when the reception unit 110 receives the information for writing generation instruction from the user terminal 200 via the network NW, the processing unit 120 generates information for writing based on function selection information at the time when the information for writing generation instruction is performed. Therefore, it is possible to construct a mechanism for generating characteristic information based on the characteristic information instruction performed on the user terminal 200 side and generating information for writing based on the information for writing generation instruction performed on the user terminal 200 side.

Then, the processing unit 120 transmits the generated information for writing to the user terminal 200 via the transmission unit 130. Accordingly, the received information for writing is written to the nonvolatile memory 450 of the real time clock device 400. Accordingly, the user can evaluate the real time clock device 400 having desired specifications.

As explained above, a processing system in the present embodiment includes: a reception unit configured to receive function selection information of a programmable real time clock device from a user terminal via a network; a processing unit configured to generate, based on the function selection information, information for writing for setting a function of the real time clock device; and a transmission unit configured to transmit the information for writing to the user terminal.

Therefore, since the information for writing is generated based on the function selection information of the programmable real time clock device, by transmitting the function selection information from the user terminal, it is possible to construct a mechanism in which the user terminal can automatically receive the information for writing. Accordingly, it is possible to improve convenience of the programmable real time clock device.

The processing unit may generate, based on the function selection information, characteristic information of the real time clock device at a time when a function selected by the user is set in the real time clock device, and the transmission unit may transmit the characteristic information to the user terminal.

Therefore, it is possible to construct a mechanism for generating the characteristic information of the real time clock device corresponding to the function selected by the user.

The characteristic information may be power consumption information.

Therefore, the user can grasp the power consumption information of the real time clock device corresponding to the set function.

In addition, when the reception unit receives a characteristic information generation instruction from the terminal via the network, the processing unit may user generate the characteristic information based on the function selection information at a time when the characteristic information generation instruction is performed. When the reception unit receives an information for writing generation instruction from the user terminal via the network, the processing unit may generate the information for writing based on the function selection information at a time when the information for writing generation instruction is performed.

Therefore, it is possible to construct a mechanism for generating the characteristic information based on the characteristic information instruction performed on the user terminal side and generating the information for writing based on the information for writing generation instruction performed on the user terminal side.

The processing unit may perform processing of displaying the characteristic information on a display unit of the user terminal.

Therefore, the user can view the characteristic information based on the function selection information through the display unit.

The real time clock device may include a clock signal generation circuit that generates a clock signal used for clocking, and the function selection information may be information for selecting frequency accuracy of the clock signal.

Therefore, it is possible to set the frequency accuracy of the clock signal of the real time clock device considering a situation of the user.

The real time clock device may include a power supply control circuit that performs charging control for a backup element by a main power supply voltage, and the function selection information may be operation setting information of the power supply control circuit.

Therefore, the user can perform operation setting for the power supply control circuit considering a situation of the user.

The power supply control circuit may perform the charging control based on comparison of a backup power supply voltage from the backup element and a threshold voltage, and the operation n setting information may be setting information of the threshold voltage.

Therefore, it is possible to set an appropriate threshold voltage according to the backup element provided in the real time clock device.

The information for writing may be information written in a nonvolatile memory of the real time clock device.

Therefore, even if power supply to the real time clock device is stopped, evaluation of the real time clock device can be continuously performed when the power supply is performed again.

The present embodiment relates to a writing system for a real time clock device, including: the processing system explained above, a user terminal, and a writing device communicably connected to the user terminal and configured to write the information for writing in a nonvolatile memory of the real time clock device.

Therefore, by selecting a function of the real time clock device, the user can construct a mechanism for immediately writing information for writing based on the selected function in the nonvolatile memory of the real time clock device.

The present embodiment relates to a function setting method for a real time clock device, including: receiving function selection information of a programmable real time clock device from a user terminal via a network; generating, based on the function selection information, information for writing for setting a function of the real time clock device; and transmitting the information for writing to the user terminal.

In the present embodiment, in addition to the function setting method for the real time clock device, the user terminal may receive the information for writing and write the received information for writing in a nonvolatile memory of the real time clock device via a writing device.

Therefore, by selecting a function of the real time clock device, the user can construct a mechanism for automatically writing information for writing based on the selected function in the nonvolatile memory of the real time clock device.

Although the embodiment is explained in detail above, those skilled in the art could easily understand that many modifications not substantially departing from the new matters and the effects of the disclosure are possible. Therefore, all such modifications are assumed to be included in the scope of the present disclosure. For example, a term described at least once together with a different term having a broader meaning or the same meaning in the specification or the drawings can be replaced with the different term at any part in the specification or the drawings. All combinations of the embodiment and the modifications are also included in the scope of the present disclosure. The configurations, the operations, and the like of the processing system, the writing system for the real time clock device, the function setting method for the real time clock device, and the like are not limited to those explained in the present embodiment. Various modified implementations are possible.

What is claimed is:

1. A processing system comprising:
a reception unit configured to receive function selection information of a programmable real time clock device from a user terminal via a network;
a processing unit configured to generate, based on the function selection information, information for writing for setting a function of the real time clock device; and
a transmission unit configured to transmit the information for writing to the user terminal.

2. The processing system according to claim 1, wherein
the processing unit generates, based on the function selection information, characteristic information of the real time clock device at a time when a function selected by the user is set in the real time clock device, and
the transmission unit transmits the characteristic information to the user terminal.

3. The processing system according to claim 2, wherein the characteristic information is power consumption information.

4. The processing system according to claim 2, wherein
when the reception unit receives a characteristic information generation instruction from the user terminal via the network, the processing unit generates the characteristic information based on the function selection information at a time when the characteristic information generation instruction is performed, and
when the reception unit receives an information for writing generation instruction from the user terminal via the network, the processing unit generates the information for writing based on the function selection information at a time when the information for writing generation instruction is performed.

5. The processing system according to claim 2, wherein the processing unit performs processing of displaying the characteristic information on a display unit of the user terminal.

6. The processing system according to claim 1, wherein
the real time clock device includes a clock signal generation circuit that generates a clock signal used for clocking, and
the function selection information is information for selecting frequency accuracy of the clock signal.

7. The processing system according to claim 1, wherein
the real time clock device includes a power supply control circuit that performs charging control for a backup element by a main power supply voltage, and
the function selection information is operation setting information of the power supply control circuit.

8. The processing system according to claim 7, wherein
the power supply control circuit performs the charging control based on comparison of a backup power supply voltage from the backup element and a threshold voltage, and
the operation setting information is setting information of the threshold voltage.

9. The processing system according to claim 1, wherein the information for writing is information written in a nonvolatile memory of the real time clock device.

10. A writing system for a real time clock device, comprising:
the processing system according to claim 1;
the user terminal; and
a writing device communicably connected to the user terminal and configured to write the information for writing in a nonvolatile memory of the real time clock device.

11. A function setting method for a real time clock device, comprising:
receiving function selection information of a programmable real time clock device from a user terminal via a network;
generating, based on the function selection information, information for writing for setting a function of the real time clock device; and
transmitting the information for writing to the user terminal.

12. The function setting method for the real time clock device according to claim 11, wherein the user terminal receives the information for writing and writes the received information for writing in a nonvolatile memory of the real time clock device via a writing device.
